(19) United States
(12) Patent Application Publication
(10) Pub. No.: US 2014/0275394 A1
(43) Pub. Date: Sep. 18, 2014

(54) SOFT-FEEL, CHEMICAL-RESISTANT POLYURETHANE COATING COMPOSITIONS

(71) Applicant: Bayer MaterialScience, LLC, Pittsburgh, PA (US)

(72) Inventor: Kathy Allen, Scenery Hill, PA (US)

(73) Assignee: Bayer MaterialScience, LLC, Pittsburgh, PA (US)

(21) Appl. No.: 14/193,353

(22) Filed: Feb. 28, 2014

Related U.S. Application Data
(60) Provisional application No. 61/781,302, filed on Mar. 14, 2013.

(51) Int. Cl. C09D 133/14

(52) U.S. Cl. CPC C09D 133/14
USPC 524/507

(57) ABSTRACT

Two-component waterborne coating compositions that form crosslinked polyurethane films exhibiting soft feel effect and high chemical resistance are disclosed. The two-component waterborne coating compositions include rubber particles and reaction products of hydroxy-functional polyacrylic polyol dispersions and water-dispersible polyisocyanates.

### BACKGROUND OF THE INVENTION

This specification relates to polyurethane coating systems, compositions, and films. This specification also relates to improving the haptic properties and chemical resistance of polyurethane coating systems, compositions, and films.

Plastic parts, such as, for example, plastic parts used in automobile interiors, are often formed from relatively hard plastics, such as, for example, polycarbonates, polyacrylates, or acrylonitrile-butadiene-styrene copolymers. Consumers often describe the tactile feel of these materials as “cheap,” “low-quality,” or otherwise lacking a pleasing texture. This may create a perception of poor quality among consumers of products comprising plastic parts.

The poor tactile feel of plastic materials may be improved by applying soft-feel coatings to the surfaces of plastic parts. Soft-feel coatings are applied to mimic the tactile feel of more expensive materials, such as, for example, suede leather, nubuck leather, velvet, or other fabrics having surface napping, which are generally perceived by consumers as being of higher quality and more luxurious. For example, in automobile interiors, soft-feel coatings may be used to coat plastic parts such as instrument panels, door panels, arm rests, head rests, airbag covers, glove compartment covers, steering wheels, handles, center consoles, and the like, to improve the haptic properties of these parts and the perceived quality of the automobile interior.

### SUMMARY OF THE INVENTION

In a non-limiting embodiment, a two-component waterborne coating system comprises a binder component comprising an aqueous dispersion and a crosslinker component comprising a water-dispersible sulfonic acid-modified polyisocyanate. The binder component comprises an aqueous dispersion of a hydroxy-functional polyacrylic polyol, an aqueous dispersion of a non-functional polyurethane, and rubber particles having an average particle size no larger than 100 microns. The two-component waterborne coating system is characterized in that a coating composition comprising the binder component and the crosslinker component forms a cured polyurethane film exhibiting a soft feel effect and no greater than a 2 rating determined in accordance with GMW14445.

In another non-limiting embodiment, a waterborne coating composition comprises a mixture of a binder component and a crosslinker component. The binder component comprises an aqueous dispersion of a hydroxy-functional polyacrylic polyol, an aqueous dispersion of a non-functional polyurethane, and rubber particles having an average particle size no larger than 100 microns. The crosslinker component comprises a water-dispersible sulfonic acid-modified polyisocyanate. The coating composition is characterized in that it forms a cured polyurethane film exhibiting a soft feel effect and no greater than a 2 rating determined in accordance with GMW14445.

In another non-limiting embodiment, a coating film applied to a substrate comprises a first polyurethane comprising a reaction product of a hydroxy-functional polyacrylic polyol and a water-dispersible sulfonic acid-modified polyisocyanate. The coating film also comprises a second polyurethane and rubber particles having an average particle size no larger than 100 microns. The coating film is characterized in that it exhibits a soft feel effect and no greater than a 2 rating determined in accordance with GMW14445.

It is understood that the invention disclosed and described in this specification is not limited to the embodiments summarized in this Summary.

### DETAILED DESCRIPTION OF THE PREFERRED EMBODIMENTS

Various embodiments are described and illustrated in this specification to provide an overall understanding of the structure, function, properties, and use of the disclosed coating compositions and applied coatings. It is understood that the various embodiments described and illustrated in this specification are non-limiting and non-exhaustive. Thus, the invention is not limited by the description of the various non-limiting and non-exhaustive embodiments disclosed in this specification. The features and characteristics described in connection with various embodiments may be combined with the features and characteristics of other embodiments. Such modifications and variations are intended to be included within the scope of this specification. As such, the claims may be amended to recite any features or characteristics expressly or inherently described in, or otherwise expressly or inherently supported by, this specification. Further, Applicant(s) reserve the right to amend the claims to affirmatively disclaim features or characteristics that may be present in the prior art. Therefore, any such amendments comply with the requirements of 35 U.S.C. §112, first paragraph, and 35 U.S.C. §132(a). The various embodiments disclosed and described in this specification can comprise, consist of, or consist essentially of the features and characteristics as variously described herein.

Any patent, publication, or other disclosure material identified herein is incorporated by reference into this specification in its entirety unless otherwise indicated, but only to the extent that the incorporated material does not conflict with existing definitions, statements, or other disclosure material expressly set forth in this specification. As such, and to the extent necessary, the express disclosure as set forth in this specification supersedes any conflicting material incorporated by reference herein. Any material, or portion thereof, that is said to be incorporated by reference into this specification, but which conflicts with existing definitions, statements, or other disclosure material set forth herein, is only incorporated to the extent that no conflict arises between that incorporated material and the existing disclosure material. Applicant reserves the right to amend this specification to expressly recite any subject matter, or portion thereof, incorporated by reference herein.

In this specification, other than where otherwise indicated, all numerical parameters are to be understood as being prefaced and modified in all instances by the term “about”, in which the numerical parameters possess the inherent variability characteristic of the underlying measurement techniques used to determine the numerical value of the parameter. At the very least, and not as an attempt to limit the application of the doctrine of equivalents to the scope of the claims, each numerical parameter described in the present description should at least be construed in light of the number of reported significant digits and by applying ordinary rounding techniques.

Also, any numerical range recited in this specification is intended to include all sub-ranges of the same numerical precision subsumed within the recited range. For example, a range of “1.0 to 10.0” is intended to include all sub-ranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited in this specification is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such sub-ranges would comply with the requirements of 35 U.S.C. §112, first paragraph, and 35 U.S.C. §132(a).

The grammatical articles “one”, “a”, “an”, and “the”, as used in this specification, are intended to include “at least one” or “one or more”, unless otherwise indicated. Thus, the articles are used in this specification to refer to one or more than one (i.e., to “at least one”) of the grammatical objects of the article. By way of example, “a component” means one or more components, thus, possibly, more than one component is contemplated and may be employed or used in an implementation of the described embodiments. Further, the use of a singular noun includes the plural, and the use of a plural noun includes the singular, unless the context of the usage requires otherwise.

A problem with prior soft feel coating compositions is that the coating films do not exhibit good chemical degradation resistance and mechanical abrasion resistance. For example, automobile manufacturers have strict standards on the resistance of interior coatings to degradation by sunscreen chemicals and insect repellant chemicals. Coating compositions that provide the necessary haptic perception to be characterized as soft feel coating compositions often do not possess sufficient resistance to sunscreen and insect repellant degradation to meet automobile manufacturer specifications.

Improvement of the chemical degradation resistance of soft-feel coatings, at a given applied film thickness, may be achieved by increasing the crosslink density and/or hard segment content of the coating polymers; e.g., by using a higher relative amount of crosslinker and/or by employing polymeric binders having higher concentrations of hard segments in the polymer backbone and/or a high concentrations of crosslinkable functional groups on the polymer backbone. However, it has been found that improvement of the chemical degradation resistance of soft feel coatings by taking such measures is accompanied by a deterioration of the soft-feel haptic properties because the cured coating films tend exhibit significant hardness. Thus, a good balance of the desired haptic properties and the chemical degradation resistance is difficult to achieve with prior soft-feel coating compositions.

Various non-limiting embodiments disclosed and described in this specification are directed, in part, to two-component waterborne coating compositions that form crosslinked polyurethane coating films that exhibit a soft feel effect and also exhibit good chemical degradation resistance. As used herein, the term “soft feel effect” refers to a particular haptic (tactile) sensation of a coated surface that is characterized as soft, velvety, suede-like, rubber-like, or a combination of any thereof. The chemical degradation resistance of the crosslinked polyurethane coating films formed from two-component waterborne coating compositions may be characterized in accordance with the General Motors Worldwide Engineering Standard GMW14445—Test Method for Sunscreen and Insect Repellent Resistance, February 2006 (“GMW14445”), which is incorporated by reference into this specification.

GMW14445 tests and rates the chemical degradation resistance of materials to a mixture consisting of four chemicals commonly found in sunscreens and insect repellants that exhibit strong solvent effects and tend to chemically degrade polymeric coatings. The test mixture is made up of equal parts by weight:

octyl methoxycinnamate [3-(4-methoxyphenyl)-2-propene acid-2-ethyl-hexyl ester];

octocrylene [2-ethylhexyl-2-cyano-3,3-diphenylacrylate];

homosalate [3,3,5-trimethylcyclohexylsalicylate]; and

DEET [N,N-diethyl-m-toluamide].

To test a coating composition, the coating composition is applied as a film onto a substrate and cured. As used herein, the term “cured” refers to the condition of a liquid coating composition in which a film formed from the coating composition is at least set-to-touch as defined in ASTM D 5895—Standard Test Methods for Evaluating Drying or Curing During Film Formation of Organic Coatings Using Mechanical Recorder, which is incorporated by reference into this specification. As used herein, the terms “cure” and “curing” refer to the progression of a liquid coating composition from the liquid state to a cured state. The terms “cured,” “cure,” and “curing” encompass physical drying of coating compositions through solvent or carrier evaporation and chemical crosslinking of components in the coating compositions.

Drops of the test mixture (approximately 50 microliters) are applied to the surface of the cured coating film to be tested, which forms a test sample. Drops of the test mixture are applied to the surface of the cured coating film in at least three different locations using a pipette. The test sample is placed in an oven or equivalent temperature-controlled environment for one hour at 80±3° C. Immediately after removing the test sample from the temperature-controlled environment, the test sample is cleaned with a detergent solution and wiped dry. The cleaned and dried test sample is cooled to a temperature of 23±5° C. and evaluated for effects of the test mixture on the cured coating films and assigned a rating in accordance with Table 1.

TABLE 1
GMW14445 Ratings

| Rating | Evaluation |
|---|---|
| 1 | No change |
| 2 | Slight change of gloss, color, swelling, |
| | or any other tolerable effects |
| 3 | Significant change of color, swelling, blisters, |
| | creases, or other non-tolerable effects |
| 4 | Very significant change of color, swelling, |
| | blisters, creases, or other non-tolerable effects |

The coating compositions described in this specification form cured polyurethane films exhibiting a soft feel effect and no greater than a 2 rating determined in accordance with GMW14445. The coating compositions described in this specification form cured polyurethane films that may exhibit a soft feel effect and a 1 rating determined in accordance with GMW14445.

The coating compositions described in this specification may also form cured polyurethane films that exhibit a soft feel effect and pass the requirements of General Motors Worldwide Engineering Standard GMW14867—Material Specification for Performance Requirements of Paints on Interior Plastic Substrates, October 2007 (“GMW14867”), which is incorporated by reference into this specification. For example, the coating compositions described in this specification may exhibit a soft feel effect and satisfy the requirements specified in section 3.6.2.1 of GMW14867, sunscreen and insect repellant resistance of coated plastic substrates.

In accordance with GMW14867 section 3.6.2.1, coating compositions are formulated to have a red color and a blue color. The red colored coating composition is applied as a film onto three panels of a plastic substrate and cured. The blue colored coating composition is also applied as a film onto three panels of a plastic substrate and cured. Additional sets of three red coated and three blue coated panels are prepared for each different plastic substrate material tested. The at least six coated panels are tested and rated in accordance with GMW14445. All of the tested panels for a given substrate and coating combination must show no greater than a 2 rating to pass GMW14867 section 3.6.2.1. In addition, the areas of the coating films exposed to the test mixture in accordance with GMW14445 are further tested for scratch resistance in accordance with General Motors Worldwide Engineering Standard GMW14698—Test Method for Scratch Resistance of Organic Coating and Self-Adhesive Foils, September 2007 (“GMW14698”), which is incorporated by reference into this specification.

In accordance with GMW14698, and as required under GMW14867 section 3.6.2.1, the previously exposed areas of the coating films must not show any film removal or observable mechanical damage after a one millimeter hemispherical tip weighted with an eight Newton load has been dragged across the surface of the exposed areas. A Rockwood Five Arm Test Device (Rockwood Systems and Equipment, Inc., Livonia, Mich., USA), or equivalent testing device, fitted with a steel (or other hard metal of ISO 18262 485 HV minimum) tip having a hemispherical diameter of 1.0±0.1 millimeter is used to perform the evaluation.

The test procedure is not performed until at least 72 hours after coating and drying. The test procedure is performed at 23±5° C. Care is taken to ensure that the test sample has attained this temperature before performing the test procedure. The test sample is placed into the testing device and the tip of the test rod is placed in contact with the coating film under a load of 8 Newtons (N). The tip is dragged across the coating film and through the exposed areas at a rate of approximately 100 millimeters per second (mm/s). The test procedure is repeated for each test sample, ensuring that all of the previously exposed areas are contacted by the moving tip. After the tip is dragged across the coating films, the previously exposed areas are evaluated for mechanical damage. The previously exposed areas of the coating film must not exhibit any breaking, cracking, peeling, or other penetration of the coating film by the test tip for the coating composition to pass the test.

The coating compositions described in this specification form cured polyurethane films exhibiting a soft feel effect and no greater than a 2 rating determined in accordance with GMW14445. The coating compositions described in this specification form cured polyurethane films that may also pass a scratch resistance test in accordance with GMW14867 and GMW14698 after chemical exposure in accordance with GMW14867 and GMW14445.

The coating compositions described in this specification may comprise two-component waterborne coating compositions. As used herein, the term “two-component” refers to a coating system or coating composition comprising at least two components that must be stored in separate containers because of their mutual reactivity. For instance, two-component polyurethane coating systems and compositions may comprise a hardener/crosslinker component comprising an isocyanate-functional compound, and a separate binder component comprising a compound that is reactive with isocyanate groups, such as, for example, a hydroxy-functional or amino-functional compound. The two separate components are generally not mixed until shortly before application because of the limited pot life of the mixture. When the two separate components are mixed and applied as a film on a substrate, the mutually reactive compounds in the two components react to crosslink and form a cured coating film.

As used herein, the term “coating system” refers to a set of chemical components that may be mixed to form an active coating composition that may be applied and cured to form a coating film. As used herein, the term “coating composition” refers to a mixture of chemical components that will cure and form a coating when applied. Accordingly, a coating composition may be formed from a coating system by mixing the chemical components comprising the coating system. Furthermore, when a list of constituents is provided in this specification that are individually suitable for forming the components of the coating system or coating composition described herein, it should be understood that various combinations of two or more of those constituents, combined in a manner that would be known to those of ordinary skill in the art reading this specification, may be employed and is contemplated.

Two-component coating systems and compositions comprise at least two mutually reactive compounds. The two mutually reactive compounds may be referred to as a binder and a hardener/crosslinker. As used herein, the term “binder” refers to the larger molecular weight reactive compound comprising a two-component coating system or composition. As used herein, the terms “hardener” and “crosslinker” are synonymous and refer to the smaller molecular weight reactive compound. For example, in a two-component polyurethane coating system or composition, the binder may comprise a polymeric polyol and the hardener/crosslinker may comprise a polyisocyanate. When mixed, a polyol binder and a polyisocyanate hardener/crosslinker may react to form a crosslinked polymer network comprising urethane and/or urea linkages. As used herein, unless indicated otherwise, the term “molecular weight” shall be interpreted to mean number average molecular weight.

As used herein, the term “dispersion” refers to a composition comprising a discontinuous phase distributed throughout a continuous phase. For example, “waterborne dispersion” and “aqueous dispersion” refer to compositions comprising particles or solutes distributed throughout liquid water. Waterborne dispersions and aqueous dispersions may also include one or more co-solvents in addition to the particles or solutes and water. As used herein, the term “dispersion” includes, for example, colloids, emulsions, suspensions, sols, solutions (i.e., molecular or ionic dispersions), and the like.

As used herein, the term “polyurethane” refers to polymeric or oligomeric materials comprising urethane groups, urea groups, or both. Accordingly, as used herein, the term “polyurethane” is synonymous with the terms polyurea, poly(urethane/urea), and modifications thereof. The term “polyurethane” also refers to polymeric or oligomeric resins or crosslinked polymer networks comprising urethane groups, urea groups, or both.

As used herein, the term “polyisocyanate” refers to compounds comprising at least two unreacted isocyanate groups. Polyisocyanates include diisocyanates and diisocyanate reaction products comprising, for example, biuret, isocyanurate, uretdione, urethane, urea, iminooxadiazine dione, oxadiazine trione, carbodiimide, acyl urea, and/or allophanate groups. As used herein, the term “polyol” refers to compounds comprising at least two free hydroxyl groups. Polyols include polymers comprising at least two pendant and/or terminal hydroxyl groups. As used herein, the term “polyamine” refers to compounds comprising at least two free amine groups. Polyamines include polymers comprising at least two pendant and/or terminal amine groups.

In various non-limiting embodiments, a two-component waterborne coating system comprises:

a binder component comprising:

(A1) an aqueous dispersion of a hydroxy-functional polyacrylic polyol;

(A2) optionally an aqueous dispersion of a non-functional polyurethane; and

(A3) rubber particles; and

(B) a crosslinker component comprising a water-dispersible polyisocyanate.

A waterborne coating composition may be formed from the two-component waterborne coating system by mixing component (A) and component (B). The waterborne coating composition may be applied to a substrate and cured to form a polyurethane film exhibiting a soft feel effect and also exhibiting no greater than a 2 rating determined in accordance with GMW14445. In this manner, dispersed polyisocyanate particles, dispersed hydroxy-functional polyacrylic polyol particles, dispersed non-functional polyurethane particles, and rubber particles coalesce into a coating film as water evaporates from the applied coating composition. The mutually-reactive polyisocyanate and hydroxy-functional polyacrylic polyol form urethane bonds as the isocyanate groups come into contract with the hydroxyl groups, thereby crosslinking and curing the coating film, which comprises the non-functional polyurethane and rubber particles distributed throughout the cross-linked polymer network.

Component (A1) may comprise a water-dispersible hydroxyl-functional polyacrylic polyol. For example, water-dispersible hydroxyl-functional polyacrylic polyol component (A1) may comprise a hydroxyl-functional acrylic dispersion as described in U.S. Patent Application Publication No. 2010/0233431, which is incorporated by reference into this specification.

Component (A1) may comprise hydroxyl-functional, polyacrylic copolymer dispersions that are prepared by free-radical polymerizing one or more vinyl monomer mixtures comprising:

hydroxyl-free (meth)acrylic esters and/or vinylaromatics;

hydroxy-functional vinyl monomers or hydroxy-functional (meth)acrylic esters;

ionic and/or potentially ionic monomers capable of free-radical copolymerization; and

optionally, additional free-radically polymerizable monomers other than monomers (a)-(c).

The free radical polymerization of (a)-(d) is performed in the presence of (e) compounds of the formula (I):

[chemical structure]

in which R₁ is an aliphatic, araliphatic, or aromatic radical having 1 to 18 carbon atoms,

R₂ is H or CH₃,

R₃ and R₄ are identical or different aliphatic radicals having 1 to 7 carbon atoms, and

n is 1 to 4.

The aqueous-dispersible, hydroxyl-functional, polyacrylic copolymer reaction product of (a)-(d) is subsequently dispersed in water before or after addition of a neutralizing agent that ionizes monomer (c) or the residues of monomer (c).

Suitable monomers of component (a) include (meth)acrylates having 1 to 18 carbon atoms in the alcohol moiety of the ester group. This alcohol moiety may be linear aliphatic, branched aliphatic, or cycloaliphatic. As used herein, the term (meth)acrylate(s) means acrylate(s) and/or methacrylate(s). Non-limiting examples of suitable monomers of component (a) include methyl (meth)acrylate, ethyl (meth)acrylate, n-propyl (meth)acrylate, n-butyl (meth)acrylate, isopropyl (meth)acrylate, isobutyl (meth)acrylate, t-butyl (meth)acrylate, pentyl (meth)acrylate, hexyl (meth)acrylate, 2-ethylhexyl (meth)acrylate, octyl (meth)acrylate, dodecyl (meth)acrylate, hexadecyl (meth)acrylate, octadecyl (meth)acrylate, cyclohexyl (meth)acrylate, trimethylcyclohexyl (meth)acrylate, isobornyl (meth)acrylate, isomers of any thereof, and combinations of any thereof.

In addition, monomers of component (a) may include acetoacetoxyethyl (meth)acrylate, acrylamide, acrylonitrile, vinyl ethers, methacrylonitrile, vinyl acetates, styrene, substituted styrenes, vinyltoluenes, isomers of any thereof, and mixtures of any thereof.

Suitable monomers of component (b) include ethylenically unsaturated monomers containing hydroxyl groups, such as, for example, hydroxyalkyl esters of unsaturated carboxylic acids. Suitable hydroxyalkyl esters of unsaturated carboxylic acids include, for example, hydroxyalkyl(meth)acrylates having 2 to 12 or 2 to 6 carbon atoms in the hydroxyalkyl radical. Non-limiting examples of suitable monomers of component (b) include 2-hydroxyethyl(meth)acrylate, the isomers of hydroxypropyl(meth)acrylate, 2-, 3- and 4-hydroxybutyl(meth)acrylates, the isomers of hydroxyhexyl(meth)acrylate, and combinations of any thereof.

In addition, monomers of component (b) may include free-radically polymerizable hydroxy-functional monomers chain-extended or modified with alkylene oxides and having a number-average molecular weight of less than or equal to 3,000 g/mol, or less than or equal to 500 g/mol. Alkylene oxides employed for this purpose include, for example, ethylene oxide, propylene oxide, butylene oxide, or combinations of any thereof.

Suitable ionic and/or potentially ionic monomers of component (c) include olefinically unsaturated monomers containing carboxylic acid or carboxylic anhydride groups, such as, for example, acrylic acid, methacrylic acid, γ-carboxyethyl acrylate, crotonic acid, fumaric acid, maleic anhydride, itaconic acid, isomers of any thereof, and combinations of any thereof. In addition, monomers of component (c) may include monoalkyl esters of dibasic (i.e., difunctional) acids or anhydrides, such as, for example, monoalkyl maleates.

In addition, monomers of component (c) may include unsaturated, free-radically polymerizable compounds containing phosphate groups, phosphonate groups, sulfonic acid groups, or sulfonate groups, which are described, for example, in International Patent Publications No. WO-A 00/39181, which is incorporated by reference into this specification. A non-limiting example of a suitable monomer of this type is 2-acrylamido-2-methylpropanesulfonic acid.

Optionally, additional monomers capable of free-radical copolymerization as monomers of component (d) may be employed. These monomers may include, for example, (meth)acrylate monomers and/or vinyl monomers with a functionality of two or more, such as, for example, hexanediol di(meth)acrylate or divinylbenzene. Further, optional monomers of component (d) may include polymerizable compounds that have a non-ionically hydrophilicizing effect, such as, for example, (meth)acrylates of hydroxy-functional polyalkylene oxide ethers.

The proportions of the synthesis components (a) to (d) may be selected so as to produce a hydroxy-functional polyacrylic polyol with an OH number of from 12 to 200 mg KOH/g solids and an acid number of from 0 to 50 mg KOH/g solids. The OH number of component (A1) may also be from 25 to 150 mg KOH/g solids or from 50 to 150 mg KOH/g solids. The acid number of component (A1) may also be from 5 to 30 mg KOH/g solids or 8 to 25 mg KOH/g solids.

Component (A1) may comprise a hydroxy-functional polyacrylic polyol copolymer reaction product of 50%-85% by weight component (a), 15%-40% by weight of component (b), 0.5-5% by weight of component (c), and 0%-34.5% by weight component (d), based on the weight of the copolymer. The relative weight percentages of components (a)-(d) may be selected so as to give hydroxy-functional polyacrylic polyol copolymers that conform to the above specifications in terms of OH number and acid number.

Component (e) may comprise a compound of formula (I) above wherein:

R₁ contains 2 to 6 carbon atoms,

R₃ and R₄ contain 1 to 7 carbon atoms,

R₂ is H or CH₃, and

n is 1 to 4.

Component (e) may comprise a compound of formula (I) above wherein:

R₁ contains 2 to 4 carbon atoms,

R₃ and R₄ contain 1 to 7 carbon atoms,

R₂ is CH₃, and

n is 2.

Non-limiting examples of suitable compounds for component (e) include reaction products of glycidyl esters of aliphatic carboxylic acids (e1) with aliphatic, araliphatic, or aromatic carboxylic acids (e2). For example, compounds for component (e) may comprise a reaction product of component (e1) and component (e2), wherein component (e1) comprises a glycidyl ester of one or more neodecanoic acids, which are carboxylic acids having the common molecular formula C₁₀H₂₀O₂, including, for example, 2-ethyl-2,5-dimethylhexanoic acid; 2,2,3,5-tetramethylhexanoic acid; 2,4-dimethyl-2-isopropylpentanoic acid; 2,5-dimethyl-2-ethylhexanoic acid; 2,2-dimethyloctanoic acid; 2,2-diethylhexanoic acid; and the like. Component (e) may comprise a reaction product of component (e1) and component (e2), wherein component (e1) comprises Cardura™ E10P, which is a glycidyl ester of the neodecanoic acid Versatic™ Acid 10, both of which are commercially available from Momentive, Columbus, Ohio, USA.

Component (e) may comprise a reaction product of component (e1) and component (e2), wherein component (e2) comprises an aliphatic, araliphatic, or aromatic carboxylic acid. Component (e2) may comprise a saturated aliphatic monocarboxylic acid, such as, for example, acetic acid, propionic acid, butyric acid, pentanoic acid, hexanoic acid, heptanoic acid, octanoic acid, 2-ethylhexanoic acid, nonanoic acid, decanoic acid, lauric acid, myristic acid, palmitic acid, margaric acid, stearic acid, arachidic acid, behenic acid, lignoceric acid, isomers of any thereof, and combinations of any thereof. In addition, or alternatively, component (e2) may comprise an unsaturated monocarboxylic acid, such as, for example, oleic acid, linoleic acid, linolenic acid, ricinoleic acid, isomers of any thereof, and combinations of any thereof.

In addition, or alternatively, component (e2) may comprise an aromatic monocarboxylic acid, a dicarboxylic acid, a polycarboxylic acid, an aromatic dicarboxylic acid, an aromatic polycarboxylic acid, a dimer fatty acid (which are obtainable by dimerizing unsaturated monocarboxylic acids), or combinations of any thereof. Example of these carboxylic acids suitable as component (e2) include benzoic acid, succinic acid, glutaric acid, adipic acid, pimelic acid, suberic acid, azelaic acid, sebacic acid, nonanedicarboxylic acid, decanedicarboxylic acid, terephthalic acid, isophthalic acid, o-phthalic acid, tetrahydrophthalic acid, hexahyrophthalic acid, trimellitic acid, isomers of any thereof, and combinations of any thereof.

Component (e) may comprise a reaction product of component (e1) and component (e2), wherein component (e1) comprises a glycidyl ester of one or more neodecanoic acids, and wherein component (e2) comprises at least one acid selected from the group consisting of 2-ethylhexanoic acid, decanoic acid, lauric acid, myristic acid, palmitic acid, stearic acid, arachidic acid, behenic acid, oleic acid, linoleic acid, linolenic acid, ricinoleic acid, succinic acid, adipic acid, a phthalic acid isomer, and combinations of any thereof. Component (e) may comprise a reaction product of component (e1) and component (e2), wherein component (e1) comprises Cardura™ E10P, and wherein component (e2) comprises adipic acid.

The compounds of component (e) can be prepared from components (e1) and (e2) before or simultaneously with the free-radical polymerization of the unsaturated monomers (a)-(d). The reaction temperature for the production of compounds of component (e) is typically from 50° C. to 200° C. or 90° C. to 140° C. In various embodiments, the compounds of component (e) are prepared from (e1) and (e2) before the free-radical polymerization of the unsaturated components (a)-(d). During the free-radical polymerization of the unsaturated components (a)-(d), the amount of component (e) present in the reaction mixture, in relation to the sum of the amounts of monomers (a) to (e) in the reaction mixture, may be 5% to 60% by weight, 10% to 30% by weight, or 15% to 30% by weight.

Optional component (A2) comprises an aqueous-dispersible, non-functional polyurethane. As used herein, the term “non-functional,” with respect to a chemical component of the two-component waterborne coating systems and compositions described in this specification, refers to a substantial lack of chemical reactivity with the hydroxyl-functional polyacrylic polyol component (A1) and the polyisocyanate crosslinker component (B). For example, a non-functional polyurethane component (A2) does not chemically react with components (A1) and/or (B) of the coating composition to form crosslinks during curing. A non-functional polyurethane component (A2) is substantially free of unreacted isocyanate groups, unreacted hydroxyl groups, isocyanate-reactive groups, hydroxyl-reactive groups, and other functional groups that may be reactive with any functional groups comprising the hydroxyl-functional polyacrylic polyol component (A1) and the crosslinker component (B). In this manner, a non-functional polyurethane component (A2) is not covalently crosslinked into the high molecular weight polymer network formed by the crosslinking reactions between the hydroxyl-functional polyacrylic polyol component (A1) and the crosslinker component (B) during curing.

As used herein, the term “substantially free,” when used in to describe a functional group content of a component, refers to complete absence or incidental residual presence of the functional group. For example, in various embodiments, non-functional polyurethane component (A2) is substantially free of hydroxyl groups, which means, for example, that the non-functional polyurethane component (A2) has an OH number of less than 6 mg KOH/g solids, and in various embodiments, less than 2.5 mg KOH/g solids. In various embodiments, non-functional polyurethane component (A2) is substantially free of unreacted hydroxyl groups, unreacted amine groups, and unreacted isocyanate groups.

Non-functional polyurethane component (A2) may comprise a water-dispersible polyester-polyurethane, a water-dispersible polyether-polyurethane, a water-dispersible polycarbonate-polyurethane, a water-dispersible polylactone-polyurethane, or combinations of any thereof. For example, water-dispersible non-functional polyurethane component (A2) may comprise an ionically-modified, substantially hydroxyl-free polyurethane as described in U.S. Patent Application Publication No. 2004/0242765, which is incorporated by reference into this specification.

The water-dispersible non-functional polyurethane component (A2) may comprise a reaction product synthesized from the following reactants:

one or more polyhydroxyl compounds having a number-average molecular weight (Mₙ) of greater than or equal to 500 Daltons and an average hydroxyl group functionality of greater than or equal to 1.5, which optionally have been treated by a distillation process at a temperature of greater than or equal to 150° C. and a pressure of less than or equal to 10 mbar to remove components volatile under these distillation conditions;

optionally, one or more polyhydroxyl compounds having a number-average molecular weight (Mₙ) of from 62 to 499 Daltons and an OH functionality of greater than or equal to 2;

optionally, one or more hydrophilic compounds having an ethylene oxide content of 50% by weight and a number-average molecular weight (Mₙ) of more than 400 Daltons, which contain at least one NCO-reactive group;

one or more polyisocyanates;

optionally, hydrazine and/or one or more aliphatic polyamines having a number-average molecular weight (Mₙ) of from 60 to 300 Daltons and at least two primary or secondary amino groups; and

one or more compounds containing at least one NCO-reactive hydrogen atom or at least one NCO group and simultaneously at least one ionic or potentially ionic group, wherein reactant (f) is different from the compounds of the above-described reactants (a)-(e).

Suitable compounds of component (a) include organic compounds based on polyester, polylactone, polyether, or polycarbonate, and having a number-average molecular weight (Mₙ) of from 500 to 10,000 Daltons, from 600 to 5,000 Daltons, or from 1,000 to 3,000 Daltons, and having an average hydroxyl functionality of from 1.5 to 6 or from 1.8 to 3. The compounds for use as component (a) may be freed from volatile components by distillation before their use as reactants to produce component (A2). This distillation may be conducted continuously in a thin-film evaporator at temperatures greater than or equal to 150° C., such as, for example, from 170-230° C. or from 180-220° C., under a reduced pressure of less than or equal to 10 mbar, such as, for example, less than or equal to 2 mbar or less than or equal to 0.5 mbar. Low molecular mass, non-reactive volatile fractions are separated from the polyhydroxyl compound under these conditions. In the course of the distillation, volatile fractions of 0.2-15% by weight, 0.5-10% by weight, or 1-6% by weight are separated off.

In various embodiments, the compounds used for (a) are substantially free of low molecular mass, non-reactive volatile fractions, wherein “substantially free” refers to the materials being present only as incidental impurities. Depending on the specific material, the material will be present at less than 1%, in some cases less than 0.5%, and in other cases less than 0.2% by weight based on the weight of component (a).

Suitable polyester polyols of component (a) are linear polyesterdiols or branched polyesterpolyols, which may be prepared in known manner from aliphatic, cycloaliphatic, or aromatic dicarboxylic or polycarboxylic acids, and/or their anhydrides, and dihydric or polyhydric alcohols. Examples of suitable carboxylic include succinic acid, glutaric acid, adipic acid, pimelic acid, suberic acid, azelaic acid, sebacic acid, nonanedicarboxylic acid, decanedicarboxylic acid, terephthalic acid, isophthalic acid, o-phthalic acid, tetrahydrophthalic acid, hexahydrophthalic acid, trimellitic acid, isomers of any thereof, and combinations of any thereof. Examples of suitable dihydric alcohols (diols) include ethanediol, diethylene glycol, triethylene glycol, tetraethylene glycol, 1,2-propanediol, dipropylene glycol, tripropylene glycol, tetrapropylene glycol, 1,3-propanediol, 1,4-butanediol, 1,3-butanediol, 2,3-butanediol, 1,5-pentanediol, 1,6-hexanediol, 2,2-dimethyl-1,3-propanediol, 1,4-dihydroxycyclohexane, 1,4-dimethylolcyclohexane, 1,8-octanediol, 1,10-decanediol, 1,12-dodecanediol, 2,2,4-trimethyl-1,3-pentanediol, 2,4,4-trimethyl-1,3-pentanediol, isomers of any thereof, and combinations of any thereof. The diols may optionally be used with lesser amounts of higher polyfunctional polyols, such as, for example, trimethylolpropane, glycerol, or pentaerythritol. Suitable polyhydric alcohols for preparing polyester polyols also include aromatic di-hydroxyl and polyhydroxyl compounds. The dihydric and polyhydric alcohols may be used in any desired mixtures, and in various embodiments linear aliphatic and/or cycloaliphatic polyhydroxyl compounds are used. In place of the free polycarboxylic acids or of the corresponding polycarboxylic anhydrides, it is also possible to use corresponding polycarboxylic esters of lower alcohols or mixtures thereof to prepare polyester polyols.

Polyester polyols may be homopolymers or copolymers of lactones (polylactones), which may be obtained by addition reaction of lactones or lactone mixtures, such as, for example, butyrolactone, ε-caprolactone, methyl-ε-caprolactone, and combinations of any thereof, with suitable difunctional and/or higher polyfunctional starter molecules, such as, for example, the polyhydric alcohols disclosed above as synthesis components for polyester polyols.

Hydroxy-functional polycarbonate polyols are also suitable as polyhydroxyl component (a). Examples include polycarbonates prepared by reacting diols, such as 1,4-butanediol and/or 1,6-hexanediol, with diaryl carbonates (e.g., diphenyl carbonate), dialkyl carbonate (e.g., dimethyl carbonate), or phosgene.

In various non-limiting embodiments, component (a) used as a reactant to produce component (A2) comprises a di-hydroxy-functional polyester polyol (diol) based on adipic acid and dyhydric alcohols such as, for example, 1,4-butanediol, 1,6-hexanediol, 2,2-dimethyl-1,3-propanediol (neopentyl glycol), and combinations of any thereof. In various non-limiting embodiments, component (a) used as a reactant to produce component (A2) comprises a di-hydroxy-functional polyester carbonate polyol (diol) based on copolymers of 1,6-hexanediol with ε-caprolactone and diphenyl carbonate. In various non-limiting embodiments, component (a) used as a reactant to produce component (A2) comprises a di-hydroxy-functional polycarbonate polyol (diol) based on 1,6-hexanediol.

In addition to the polyols of the aforementioned kind, component (a) may also include up to 50% by weight of polyether polyols, such as, for example, the polyadducts of styrene oxide, ethylene oxide, propylene oxide, tetrahydrofuran, butylene oxide, epichlorohydrin, and combinations of any thereof. Suitable polyether polyols include mixed addition products and graft products, the polyols obtained by condensing polyhydric alcohols, and the polyols obtained by alkoxylating polyfunctional alcohols, amines, and amino alcohols.

Suitable compounds of optional component (b) include low molecular weight polyols having a number-average molecular weight Mₙ of 62 to 499 Daltons. Examples include the polyhydric and dihydric alcohols disclosed above for the preparation of polyester polyols of component (a). Examples also include low molecular weight polyester diols, such as bis(hydroxyethyl) adipate, for example, and short-chain homo-addition and mixed-addition products of ethylene oxide and/or propylene oxide that are prepared starting from aromatic diols. In various embodiments, compounds of component (b) may include 1,4-butanediol and 1,6-hexanediol.

Suitable compounds of optional component (c) may have a number-average molecular weight of at least 400 Daltons, least 500 Daltons, or at least 1200 Daltons. Suitable compounds of optional component (c) may have a number-average molecular weight from 1200 to 4500 Daltons and correspond to the formula (II):

H—Y′—X—Y—R Formula (II)

in which R is a monovalent hydrocarbon radical having 1 to 12 carbon atoms, and in various embodiments, R is an unsubstituted alkyl radical having 1 to 4 carbon atoms;

X is a polyalkylene oxide chain having 5 to 90 monomer units, or in some embodiments 20 to 70 monomer units, and the ethylene oxide content is at least 50% by weight, and in some embodiments, at least 65% by weight or 55% to 89% by weight, based on the compound of the formula (I);

Y and Y′, independently of each other, are oxygen or —NR—, where R′ is hydrogen or an unsubstituted alkyl radical having 1 to 4 carbon atoms.

The group X can contain, besides ethylene oxide, also propylene oxide, butylene oxide and/or styrene oxide units.

Suitable compounds of optional component (c) may include mono-functional, hydrophilic polyethers prepared as described in DE-A 2314512, DE-A-2314513, and U.S. Pat. Nos. 3,905,929 and 3,920,598, which are incorporated by reference into this specification. These mono-functional, hydrophilic polyethers may be prepared by alkylating a monofunctional starter such as n-butanol or N-methylbutylamine, for example, using ethylene oxide and, optionally, a further alkylene oxide such as propylene oxide.

Suitable compounds of component (d) include any desired organic compounds, individually or in mixtures with one another, which contain at least two unreacted isocyanate groups per molecule. Suitable polyisocyanates which may be used as component (d) to produce component (A2) include aromatic, aliphatic, and/or cycloaliphatic polyisocyanates. Aromatic, aliphatic, and/or cycloaliphatic polyisocyanates may include monomeric organic diisocyanates represented by the formula, R(NCO)₂, in which R represents an organic group. In various embodiments, R represents a divalent aliphatic hydrocarbon group having from 4 to 18 carbon atoms, a divalent cycloaliphatic hydrocarbon group having from 5 to 15 carbon atoms, a divalent araliphatic hydrocarbon group having from 7 to 15 carbon atoms, or a divalent aromatic hydrocarbon group having 6 to 15 carbon atoms.

Examples of suitable diisocyanates include: 1,4-tetra-methylene diisocyanate; methylpentamethylene diisocyanate; 1,6-hexamethylene diisocyanate (HDI); 2,2,4-trimethyl-1,6-hexamethylene diisocyanate; 1,12-dodecamethylene diisocyanate; cyclohexane-1,3- and -1,4-diisocyanate; 1-isocyanato-2-isocyanatomethyl cyclopentane; 1-isocyanato-3-isocyanatomethyl-3,5,5-trimethyl-cyclohexane (isophorone diisocyanate or IPDI), bis-(4-isocyanato-cyclohexyl)-methane; 1,3- and 1,4-bis-(isocyanatomethyl)-cyclohexane; bis-(4-isocyanatocyclo-hexyl)-methane; 2,4′-diisocyanato-dicyclohexyl methane; bis-(4-isocyanato-3-methyl-cyclohexyl)-methane; α,α,α′,α′-tetramethyl-1,3- and/or -1,4-xylylene diisocyanate; 1-isocyanato-1-methyl-4(3)-isocyanatomethyl cyclohexane; 2,4- and/or 2,6-hexahydro-toluoylene diisocyanate; 1,3- and/or 1,4-phenylene diisocyanate; 2,4- and/or 2,6-toluene diisocyanate; 2,4- and/or 4,4′-diphenylmethane diisocyanate (MDI); 1,5-diisocyanato naphthalene; and combinations of any thereof.

Monomeric polyisocyanates containing three or more isocyanate groups such as 4-isocyanatomethyl-1,8-octamethylene diisocyanate and aromatic polyisocyanates such as 4,4′,4″-triphenylmethane triisocyanate and polyphenyl polymethylene polyisocyanates obtained by phosgenating aniline/formaldehyde condensates may also be used to prepare isocyanate-functional polyurethanes. Also suitable are polyisocyanate adducts prepared from monomeric polyisocyanates (including diisocyanates) and containing isocyanurate, uretdione, biuret, urethane, allophanate, iminooxadiazine dione, carbodiimide, and/or oxadiazinetrione groups.

In various embodiments, the polyisocyanate component (d) used to produce component (A2) is selected from the group consisting of HDI, IPDI, 2,4′-diisocyanatodicyclohexylmethane, 4,4′-diisocyanatodicyclohexylmethane, polyisocyanate adducts of any thereof, and combinations of any thereof.

Suitable compounds of optional component (e) include hydrazine and aliphatic and/or cycloaliphatic primary and/or secondary polyamines having at least two primary or two secondary amino groups. Examples include 1,2-ethanediamine, 1,6-hexamethylenediamine, 1-amino-3,3,5-trimethyl-5-aminomethylcyclohexane (isophoronediamine), piperazine, 1,4-diaminocyclohexane, bis-(4-aminocyclohexyl) methane, adipic dihydrazide, diethylenetriamine, and combinations of any thereof. In addition, component (e) may also comprise polyether polyamines. In various embodiments, the polyisocyanate component (e) used to produce component (A2) is selected from the group consisting of hydrazine, isophoronediamine, 1,2-ethanediamine, piperazine, diethylenetriamine, and combinations of any thereof.

Suitable compounds of component (f) comprise at least one isocyanate-reactive group or at least one isocyanate group and simultaneously at least one ionic group or one potentially ionic group. Examples of such compounds include quaternary amino-containing alcohols, hydroxycarboxylic acids, hydroxysulfonic acids, aminocarboxylic acids, or aminosulfonic acids, which are described, for example, in U.S. Pat. No. 3,479,310, which is incorporated by reference into this specification. These compounds may be employed in an ionic or potentially ionic form. Where potentially ionic synthesis components are used, the at least partial conversion of the potentially ionic groups into ionic groups by quaternization or neutralization may take place during or after the preparation of the component (A2). Suitable quaternizing and/or neutralizing agents for converting potentially ionic groups into ionic groups are also described, for example, in U.S. Pat. No. 3,479,310.

Examples of suitable compounds of component (f) include carboxyl- and/or carboxylate-containing diols, such as, 2,2-bis(hydroxymethyl)alkanoic acids, such as, for example, dimethylolacetic acid, dimethylolpropanoic acid, dimethylolbutyric acid, dimethylolpentanoic acid dihydroxysuccinic acid, and combinations of any thereof. In addition, diamines and polyamines containing sulfonic acid or sulfonate groups are also suitable as compounds of component (f). In various embodiments, the component (f) used to produce component (A2) is selected from the group consisting of dimethyloipropionic acid, N-(2-aminoethyl)-2-aminoethanesulfonic acid, salts thereof, and combinations of any thereof.

The non-functional polyurethane component (A2) may be produced in the absence or presence of catalysts. Suitable catalysts are known in the art of polyurethane chemistry and include, for example, tertiary amines such as triethylamine, and tin compounds such as tin(II) octoate, dibutyltin oxide, and dibutyltin dilaurate. Suitable reaction processes for the production of dispersions of non-functional polyurethane component (A2) include emulsifier/shear-force processes, acetone processes, prepolymer-mixing processes, melt-emulsification processes, ketimine processes, and spontaneous solids-dispersing processes (or processes derived therefrom). A description of suitable processes may be found, for example, in Methoden der Organischen Chemie, Houben-Weyl, 4th Edition, Volume E20/Part 2, Georg Thieme Verlag, Stuttgart, 1987, which is incorporated by reference into this specification.

In the acetone process, for example, the synthesis of an aqueous dispersion non-functional polyurethane component (A2) takes place in a multi-stage process.

In a first stage, a prepolymer containing isocyanate groups is synthesized from synthesis components (a) to (d) and, optionally, (f). The amounts in which the individual components are used are such as to result in a ratio of NCO groups to the sum of OH and NH groups (isocyanate index) of from 1.1 to 3.5, and in some embodiments from 1.3 to 2. The isocyanate content of the resulting prepolymers may be 1.5% to 7.5% by weight, and in some embodiments, from 2% to 4.5% by weight or from 2.5% to 3.5% by weight. When calculating the amount of the synthesis components (a) to (d), care should be taken to ensure that the arithmetic, number-average functionality of the prepolymer to be prepared is from 1.80 to 3.50, and in some embodiments, from 1.95 to 2.25.

In a second stage, the prepolymer prepared in the first stage is dissolved in an at least partly water-miscible organic solvent that carries no isocyanate-reactive groups, such as, for example acetone, 2-butanone, tetrahydrofuran, dioxane, or mixtures of these solvents. The solvent quantities should be such as to result in a solids content of from 30% to 70% by weight, and in some embodiments, from 35% to 60% by weight or from 40% to 55% by weight.

In a third stage, the isocyanate-containing prepolymer solution from the second stage is reacted with the optional amino-functional component (e) and with component (f), if component (f) has not yet been added in the first stage, or has been added only partly. In the third stage, chain extension produces a relatively high molecular weight polyurethane resin. The amounts of optional component (e) and component (f), if applicable, are calculated so that there is from 0.3 to 0.93 mol of isocyanate-reactive groups in component (e) and/or component (f) per mole of isocyanate groups in the dissolved prepolymer. In some embodiments, the amounts of optional component (e) and component (f), if applicable, are calculated so that there is from 0.5 to 0.85 mol of isocyanate-reactive groups in component (e) and/or component (f) per mole of isocyanate groups in the dissolved prepolymer.

The arithmetic, number-average isocyanate functionality of the resultant ionically-modified polyurethane may be between 1.55 and 3.10, and in some embodiments, between 1.90 and 2.35, The arithmetic, number-average molecular weight (Mₙ) may be 4500-250,000 Daltons, and in some embodiments, 10,000-40,000 Daltons.

In a fourth stage, the high molecular weight polyurethane resin is precipitated by addition of water in the form of a fine aqueous dispersion. The amount of water is calculated such that the formulations have a solids content of from 30% to 70% by weight after removal of the organic solvent. In some embodiments, the amount of water is calculated such that the formulations have a solids content of from 35% to 60% by weight or from 40% to 55% by weight after removal of the organic solvent.

If potentially ionic compounds are employed as synthesis component (f) they must be converted into the ionic form before the precipitation of the polyurethane with water by adding suitable bases or acids. Bases that can be used include tertiary amines such as, for example, triethylamine, triisopropylamine, ethyl-diisopropylamine, triethanolamine, or triisopropanolamine. Inorganic bases such as alkali metal or alkaline earth metal hydroxides, carbonates, or hydrogen carbonates may also be used. In a fifth stage, organic solvent present is removed completely or partially by distillation.

The fraction of optional component (c), if used, may be less than 10 mol % based on the amount of the polyisocyanate component (d) used, which may ensure the desired high molecular mass structure of the polyurethane polymers.

In various embodiments, component (A2) is prepared by reacting;

from 30.0 to 83.5 parts by weight of component (a);

from 0 to 30 parts by weight of component (b);

from 0 to 10 parts by weight of component (c);

from 15 to 50 parts by weight of component (d);

from 0.5 to 13 parts by weight of component (e); and

from 1 to 8 parts by weight of component (f).

In some embodiments, component (b) may be from 0 to 15 parts by weight, component (c) may be from 1 to 10 parts by weight, component (d) may be from 20 to 40 parts by weight, component (e) may be from 1 to 5 parts by weight, and component (f) may be from 1.5 to 5.5 parts by weight. These components may be used in the above-described multi-stage acetone process in amounts such that the individual components (a)-(f) add up to 100 parts by weight.

In some embodiments, the amounts of the individual components (a)-(f) are calculated such that largely hydroxyl-free ionically-modified polyurethane dispersions are obtained with an ionic group content of from 1.5 to 50, and in some embodiments, from 3.0 to 35 or 3.5 to 15 mmol/100 g solids, and the hydroxyl group content corresponds to an OH number of less than 6 mg KOH/g, and in some embodiments, less than 2,5 mg KOH/g.

In some embodiments, the amounts of the individual components (a)-(f) are calculated such as to produce largely hydroxyl-free ionically-modified polyurethane dispersions that, in addition to ionic groups, contain from 0.1% to 20% by weight, based on solids, of non-ionically hydrophilic groups in the form of polyethylene oxide units. In some embodiments, component (A2) comprises from 0.5% to 10% by weight or from 0.9% to 4% by weight, based on solids, of non-ionically hydrophilic groups in the form of polyethylene oxide units.

Component (A3) comprises rubber particles. As used herein, the term “rubber” refers to vulcanized elastomer materials that exhibit large and reversible elongations at low stresses. Rubbers are generally amorphous with a low glass transition temperature and some degree of crosslinking (vulcanization) to impart elastic material properties. Rubbers include, but are not limited to, natural and synthetic polyisoprene, polychloroprene (neoprene), polybutadiene, polyacrylonitrile, poly(styrene-co-butadiene), poly(acrylonitrile-co-butadiene), poly(isobutylene-co-isoprene), polysulfide rubbers, ethylene propylene diene monomer (EPDM) rubbers, butyl rubbers, silicone rubbers, and the like. Rubber also includes blends and other combinations of vulcanized elastomer materials, including, but not limited to, tire rubber.

In various embodiments, component (A3) may comprise crumb rubber particles recycled from used tires. As used herein, the term “crumb rubber” refers to particles derived by reducing scrap rubber tire or other rubber material into particles. Generally, crumb rubber production processes for recycling tires include operations to remove any reinforcing materials such as steel and fiber, along with other contaminants such as dust, glass, rocks, and the like. Crumb rubber production processes include, but are not limited to, the grinding of vulcanized (crosslinked) rubber (for example, tire rubber) into crumb rubber particles of various sizes under ambient or cryogenic conditions.

Non-limiting examples of cryogenic grinding processes and apparatuses that produce rubber particles from recycled tires are described in U.S. Pat. Nos. 7,093,781; 7,108,207; and 7,445,170, which are incorporated by reference into this specification. In various embodiments, component (A3) may comprise crumb rubber particles produced by the processes and/or with the apparatuses described in U.S. Pat. Nos. 7,093,781; 7,108,207; and 7,445,170. Crumb rubber particles produced by the processes and/or with the apparatuses described in U.S. Pat. Nos. 7,093,781; 7,108,207; and 7,445,170 include the PolyDyne™ and the MicroDyne™ lines of products commercially available from Lehigh Technologies Inc., Tucker, Ga., USA.

Tire rubber includes various different types of rubbers depending, for example, on the tire manufacturer's formulations, the type of tire, and the spatial location of the rubber material within the tire structure. In embodiments comprising rubber particles produced from recycled tires, the vulcanized rubber particles may contain a combination of several different rubbers, as well as other tire material components, such as, for example, thermoplastic polymers, carbon black, silica, clays, anti-oxidant compounds, anti-ozonant compounds, free sulfur, other free vulcanizing agents, oils, residual fibers, residual steel, other residual contaminants, and the like.

In various embodiments, component (A3) may comprise rubber particles produced from rubber recycled from non-tire sources. In various embodiments, component (A3) may comprise rubber particles produced from a virgin rubber or combinations of virgin rubbers. Rubber particles finding utility in the described coating systems and compositions may also include various additives, for example, ingredients known in the art of rubber material production and processing.

In various embodiments, the coating systems, compositions, and films described herein may comprise rubber particles having an average particle size of 40 Mesh to 300 Mesh, as determined according to ASTM D5644-01: Standard Test Methods for Rubber Compounding Materials Determination of Particle Size Distribution of Recycled Vulcanizate Particulate Rubber, incorporated by reference into this specification. In various embodiments, the average particle size may fall within any sub-range within 40 Mesh to 300 Mesh, as determined according to ASTM D5644-01. For example, in various embodiments, the average particle size of rubber particles may be no larger than 40 Mesh (approximately 400 microns), 80 Mesh (approximately 177 microns), 140 Mesh (approximately 105 microns), 200 Mesh (approximately 74 microns), or 300 Mesh (approximately 50 microns), as determined according to ASTM D5644-01.

In various embodiments, the rubber particles may have an average particle size no larger than any value in the range of 50 microns to 500 microns. In various embodiments, the rubber particles may have an average particle size no larger than any value in any sub-range within 50 microns to 500 microns. For example, the rubber particles may have an average particle size no larger than 500 microns, 400 microns, 300 microns, 200 microns, 100 microns, 75 microns, or 50 microns. In various embodiments, the rubber particles may have an average particle size in the range of 25 microns to 500 microns, or any sub-range subsumed therein, such as, for example, 25 microns to 75 microns, 35 microns to 65 microns, or 45 microns to 55 microns.

The coating systems, compositions, and films described herein may comprise ground rubber particles produced from recycled rubber tires having an average particle size of 40 Mesh to 300 Mesh, or any sub-range or value within 40 Mesh to 300 Mesh, as determined according to ASTM D5644-01. The coating systems, compositions, and films described herein may comprise ground rubber particles produced from recycled rubber tires having an average particle size no larger than any value in the range of 50 microns to 500 microns, or any sub-range or value within 50 microns to 500 microns. In various embodiments, component (A3) comprises cryogenically ground rubber particles produced from recycled rubber tires.

Component (B) may comprise a water-dispersible polyisocyanate. For example, water-dispersible polyisocyanate component (B) may comprise (i) an amino-sulfonic acid-modified polyisocyanate as described in U.S. Patent Application Publication No. 2010/0233431, which is incorporated by reference into this specification. Other water-dispersible polyisocyanates may also be included as component (B), such (ii) where a hydrophilic polyether segment is reacted with a hydrophobic polyisocyanate, an example of which is Bayhydur 302, Bayer MaterialScience LLC. In some embodiments, component (B) comprises (B)(i) and (B)(ii) in a relative weight ratio of 1:5 to 5:1, such as 1:2 to 2:1 or 1:2 to 1:1.

Component (B) includes modified polyisocyanates that are obtainable by reaction of polyisocyanates with 2-(cyclohexylamino)-ethanesulfonic acid (CHES) and/or 3-(cyclohexylamino)-propanesulfonic acid (CAPS). These ionically-modified polyisocyanates are dispersible in water after neutralization (ionization) of at least a proportion of the sulfonic acid groups.

Suitable water-dispersible ionically-modified polyisocyanates may have an average isocyanate functionality of at least 1.8; a content of isocyanate groups (calculated as NCO; molecular weight 42 Daltons) of 4.0% to 26.0% based on the molecular weight of the polyisocyanate molecules; a content of sulfonate groups (calculated as SO₃⁻; molecular weight of 80 Daltons) of 0.1% to 7.7% based on the molecular weight of the polyisocyanate molecules; and, optionally, a content of ethylene oxide units bonded within polyether chains (calculated as C₂H₂O; molecular weight of 44 Daltons) of 0% to 19.5% based on the molecular weight of the polyisocyanate molecules, wherein the polyether chains contain a statistical average of 5 to 55 ethylene oxide units. Suitable water-dispersible ionically-modified polyisocyanates are obtainable by reaction of aliphatic, cycloaliphatic, araliphatic, and/or aromatic polyisocyanates (including diisocyanates) with 2-(cyclohexylamino)-ethanesulfonic acid and/or 3-(cyclohexylamino)-propanesulfonic acid.

For example, a reaction to produce water-dispersible ionically-modified polyisocyanates for component (B) may be carried out by a procedure in which the following reactants are reacted together:

(a) a polyisocyanate component with an average functionality of 2.0 to 5.0 and a content of aliphatically, cycloaliphatically, araliphatically, and/or aromatically bonded isocyanate groups (calculated as NCO; molecular weight of 42 Daltons) of 8.0% to 27.0% based on the molecular weight of the polyisocyanate molecules;

(b) 0.3% to 25.0%, based on the total weight of components (a)-(c), of 2-(cyclohexylamino)-ethanesulfonic acid and/or 3-(cyclohexylamino)-propanesulfonic acid; and

(c) optionally, up to 25%, based on the total weight of components (a)-(c), of a monohydric polyalkylene oxide polyether alcohol containing a statistical average of 5 to 35 ethylene oxide units.

The reaction of components (a)-(c) may be performed in the presence of (d) 0.2 to 2.0 equivalents, based on the sulfonic acid groups of component (b), of a tertiary amine. The reactant components (a)-(c) may be reacted together at an equivalent ratio of NCO groups to groups that are reactive towards NCO groups (e.g., hydroxyl groups and amine groups) (i.e., NCO:OH+NHₓ) of 2:1 to 400:1. The nature and ratio of amounts of the starting compounds (a)-(c) may be otherwise chosen such that the resulting reaction products meet the conditions mentioned above under (a) to (d).

Component (a) may have an average NCO functionality of 2.0 to 5.0, and in some embodiments, of 2.3 to 4.5, and a content of isocyanate groups of 8.0% to 27.0%, and in some embodiments, of 14.0% to 24.0% (by weight), and a content of monomeric diisocyanates of less than 1%, and in some embodiments, of less than 0.5% (by weight). Component (a) may comprise at least one organic polyisocyanate with aliphatically, cycloaliphatically, araliphatically, and/or aromatically bonded isocyanate groups.

The polyisocyanates of component (a) may be produced from at least two diisocyanates by addition of aliphatic, cycloaliphatic, araliphatic, and/or aromatic diisocyanates, and having a uretdione, isocyanurate, allophanate, biuret, iminooxadiazinedione, and/or oxadiazinetrione structure, such as are described by way of example, in J. Prakt. Chem. 33.6 (1994) 185-200; DE-A 1670666; DE-A 1954093; DE-A 2414413; DE-A 2452532; DE-A 2641380; DE-A 3700209; DE-A 3900053; DE-A 3928503; EP-A 0336205; EP-A 0339396; and EP-A 0798299, which are incorporated by reference into this specification.

Suitable diisocyanates for the preparation of such polyisocyanates include the diisocyanates described above in connection with the production of the non-functional polyurethane component (A2), such as, for example, 1,4-diisocyanatobutane, 1,6-diisocyanatohexane (HDI), 2-methyl-1,5-diisocyanatopentane, 1,5-diisocyanato-2,2-dimethylpentane, 2,2,4- and 2,4,4-trimethyl-1,6-diisocyanatohexane, 1,10-diisocyanitodecane, 1,3- and 1,4-diisocyanatocyclohexane, 1,3- and 1,4-bis-(isocyanatomethyl)-cyclohexane, 1-isocyanate-3,3,5-trimethyl-5-isocyanatomethylcyclohexane (isophorone-diisocyanate, IPDI), 4,4′-diisocyanatodicyclohexylmethane, 1-isocyanato-1-methyl-4(3)isocyanato-methylcyclohexane, bis-(isocyanatomethyl)-norbornane, 1,3- and 1,4-bis-(2-isocyanato-prop-2-yl)-benzene (TMXDI), 2,4- and 2,6-diisocyanatotoluene (TDI), 2,4′- and 4,4′-diisocyanatodiphenylmethane (MDI), 1,5-diisocyanatonaphthalene, isomers of any thereof, and combinations of any thereof.

In various embodiments, the starting components (a) may be polyisocyanates with an isocyanurate (symmetric trimer) structure based on HDI, IPDI, and/or 4,4′-diisocyanatodicyclohexylmethane.

In addition, polyisocyanates that are hydrophilically-modified with ethylene oxide polyethers are suitable as component (a). Examples of such polyisocyanates are obtainable, for example, by the processes described in EP-A 0959087, which is incorporated by reference into this specification.

In various embodiments, component (b) is 2-(cyclohexylamino)-ethanesulfonic acid (CHES), 3-(cyclohexylamino)-propanesulfonic acid (CAPS), or a combination thereof. These aminosulfonic acids may be employed in the production of component (B) in amounts of 0.3% to 25%, and in some embodiments, 0.5% to 25%, by weight based on the total weight of components (a)-(c).

Optional component (c) may be a monohydric polyalkylene oxide polyether alcohols that contains a statistical average of 5 to 35, and in some embodiments, 7 to 30 ethylene oxide units per molecule. These molecules are obtainable, for example, by alkoxylation of suitable starter molecules as described in Ullmanns Encyclopadie der technischen Chemie, 4th edition, volume 19, Verlag Chemie, Weinheim p. 31-38, which is incorporated by reference into this specification.

Suitable starter molecules for the preparation of a polyether alcohol for use as optional component (c) include, for example, saturated monoalcohols, such as methanol, ethanol, n-propanol, isopropanol, n-butanol, isobtitanol, sec-butanol, the isomeric pentanols, hexanols, octanols and nonanols, n-decanol, n-dodecanol, n-tetradecanol, n-hexadecanol, n-octadecanol, cyclohexanol, the isomeric methylcyclohexanols, hydroxymethylcyclohexane, 3 ethyl-3-hydroxymethyloxetane, or tetrahydrofurfuryl alcohol; unsaturated alcohols, such as allyl alcohol, 1,1-dimethyl-allyl, alcohol, or oleyl alcohol, aromatic alcohols such as phenol, the isomeric cresols, methoxyphenols; araliphatic alcohols, such as benzyl alcohol, anisyl alcohol, or cinnamyl alcohol; secondary monoamines, such as dimethylamine, diethylamine, dipropylamine, diisopropylamine, di-n-butylamine, diisobutylamine, bis-(2-ethylhexyl)-amine, N-methyl- and N-ethylcyclohexylamine, or dicyclohexylamine; heterocyclic secondary amines, such as morpholine, pyrrolidine, piperidine, or 1H-pyrazole; and combinations of any thereof.

In various embodiments, starter molecules are saturated monoalcohols having up to 4 carbon atoms, and in some embodiments, methanol is used as a starter molecule. Starter molecules are alkoxylated using ethylene oxide and/or propylene oxide, for example, which can be employed in an alkoxylation reaction alone, in any desired sequence, or as a mixture. Polyalkylene oxide polyether alcohols of optional component (c) may be pure polyethylene oxide polyethers or mixed polyalkylene oxide polyethers. For example, the alkylene oxide units of mixed polyalkylene oxide polyethers may comprise ethylene oxide units of at least 30 mol %, and in some embodiments, at least 40 mol %. In various embodiments, polyalkylene oxide polyether alcohols of optional component (c) may comprise polyethylene glycol monomethyl ether alcohols that contain a statistical average of 7 to 30, and in some embodiments, 7 to 25 ethylene oxide units.

Polyalkylene oxide polyether alcohols of optional component (c) may be employed, if at all, in amounts of up to 25%, and in some embodiments, up to 20%, by weight based on the total weight of components (a)-(c).

Tertiary amine component (d) may be employed for neutralization of the sulfonic acid groups of starting components (b). Suitable tertiary amines include, for example, tertiary monoamines such as trimethylamine, methylamine, tripropylamine, tributylamine, dimethylcyclohexylamine, N-methylmorpholine, N-ethylmorpholine, N-methylpiperidine, or N-ethylpiperidine; tertiary diamines such as 1,3-bis-(dimethylamino)-propane, 1,4-bis-(dimethylamino)-butane, or N,N″-dimethylpiperazine; and combinations of any thereof. Tertiary amines that carry groups that are reactive towards isocyanates may be suitable, but are less preferred neutralization amines, and include, for example, alkanolamines such as dimethylethanolamine, methyldiethanolamine, or triethanolamine.

Tertiary amine component (d) may be employed to produce water-dispersible polyisocyanate component (B) in amounts that correspond to an equivalent ratio of tertiary amino groups to sulfonic acid groups of component (b) of 0.2 to 2.0, and in some embodiments, of 0.5 to 1.5.

To water-dispersible polyisocyanate component (B), the starting components (a)-(c) may be reacted with one another in the presence of a tertiary amine (d) at temperatures of 40° C. to 150° C., and in some embodiments, of 50° C. to 130° C., observing an equivalent ratio of NCO groups to groups which are reactive towards NCO groups of 2:1 to 400:1, and in some embodiments, of 4:1 to 250:1. The reaction may be run until a theoretically calculated NCO content is reached.

The presence of the tertiary amine of component (d) may catalyze the reaction of components (a), (b) and optionally (c) sufficiently, but further conventional catalysts known from polyurethane chemistry may optionally be employed to accelerate the reaction. For example, additional tertiary amines may be used, such as triethylamine, pyridine, methylpyridine, benzyldimethylamine, N,N-endoethylenepiperazine, N-methylpiperidine, pentamethyldiethylenetriamine, N,N-dimethyl-aminocyclohexane, or N,N′-dimethylpiperazine; or metal salts, such as iron(III) chloride, aluminium tri(ethyl-acetoacetate), zinc chloride, zinc(II) n-octanoate, zinc(II) 2-ethyl-1-hexanoate, zinc(II) 2-ethylcaproate, zinc(II) stearate, zinc(II) naphthenate, zinc(II) acetylacetonate, tin(II) n-octanoate, tin(II) 2-ethyl-1-hexanoate, tin(II) ethylcaproate, tin(II) laurate, tin(II) palmitate, dibutyltin(IV) oxide, dibutyltin(IV) dichloride, dibutyltin(IV) diacetate, dibutyltin(IV) dimaleate, dibutyltin(IV) dilaurate, dioctyltin(IV) diacetate, or molybdenum glycollate; or combinations of any thereof. These additional catalysts may be employed, if at all, in an amount of 0.001% to 2%, an in some embodiments, of 0.005% to 0.5%, by weight based on the total weight of the reaction components.

The preparation of water-dispersible polyisocyanate component (B) may be carried out in a suitable solvent that is inert towards isocyanate groups. Suitable solvents include, for example, ethyl acetate, butyl acetate, ethylene glycol monomethyl or -ethyl ether-acetate, 1-methoxyprop-2-yl acetate, 3-methoxy-n-butyl acetate, acetone, 2-butanone, 4-methyl-2-pentanone, cyclohexanone, toluene, xylene, chlorobenzene, white spirit; more highly substituted aromatics such as are commercially available, for example, under the names Solvent Naphtha, Solvesso®, Isopar®, Nappar®, Shellsol®; carbonic acid esters such as dimethyl carbonate, diethyl carbonate, 1,2-ethylene carbonate, and 1,2-propylene carbonate; lactones such as β-propiolactone, γ-butyrolactone, ε-caprolactone and ε-methylcaprolactone; other solvents such as propylene glycol diacetate, diethylene glycol dimethyl ether, dipropylene glycol dimethyl ether, diethylene glycol ethyl and butyl ether-acetate, N-methylpyrrolidone, N-methylcaprolactam; or combinations of any thereof.

The nature and ratios of amounts of the starting components (a)-(c) for the production of water-dispersible polyisocyanate component (B) may be otherwise chosen such that the resulting polyisocyanates correspond to the specifications described above, for example, wherein the average NCO functionality of component (B) is 2.0 to 4.8, and in some embodiments 2.4 to 3.8; the NCO content is 7.0% to 23.0%, and in some embodiments, 10.0% to 22.0% by weight of component (B); the content of sulfonate groups (calculated as SO₃⁻; molecular weight of 80 Daltons) is 0.2% to 6.3%, and in some embodiments, 0.6% to 4.8% by weight of component (B); and the content of ethylene oxide units bonded within polyether chains up to 17%, and in some embodiments, up to 15% by weight of component (B).

In various non-limiting embodiments, a two-component waterborne coating system comprises:

a binder component comprising:

(A1) an aqueous dispersion of a hydroxy-functional polyacrylic polyol;

(A2) an aqueous dispersion of a non-functional polyurethane; and

(A3) rubber particles; and

(B) a crosslinker component comprising a water-dispersible polyisocyanate;

wherein these components may be prepared as described above. A waterborne coating composition may be formed from the two-component waterborne coating system by mixing component (A) and component (B).

In various non-limiting embodiments, a two-component waterborne coating system may comprise a binder component comprising a mixture of Bayhydrol® resins (available from Bayer MaterialScience LLC, Pittsburgh, Pa., USA) and PolyDyne™ or MicroDyne™ rubber; and a crosslinker component comprising a Bayhydur® crosslinking agent (available from Bayer MaterialScience LLC, Pittsburgh, Pa., USA). For example, a two-component waterborne coating system may comprise a binder component comprising a mixture of Bayhydrol® A 2695 and Bayhydrol® A 2546, and MicroDyne™ 50; and a crosslinker component comprising Bayhydur® 302 and Bayhydur XP 2487/1.

The two-component waterborne coating systems or compositions described in this specification may comprise conventional auxiliary agents or additives appropriate for the system or composition end use. For example, auxiliary agents or additives may include, but are not limited to, defoamers, rheology modifiers (e.g., thickeners), leveling agents, flow promoters, pigments, dispersing agents, catalysts, anti-skinning agents, anti-sedimentation agents, and/or emulsifiers,

The binder component of the two-component systems described in this specification may comprise water as the predominant evaporative carrier for the aqueous dispersion, and optionally, one or more organic co-solvents. Optional organic co-solvents may include, but are not limited to, acetone, xylene, butyl carbitol, butyl acetate, ethyl acetate, hexyl acetate mixtures, butyl glycol acetate, dipropylene glycol n-butyl ether, methoxypropyl acetate, hydrocarbons such as the Aromatic® solvents (Exxon Mobile Chemicals), propylene glycol monomethyl ether acetate, N-methylpyrrolidone, or combinations of any thereof. The organic solvents may be utilized, if at all, in limited quantities as necessary given the particular chemical components of a specific embodiment of a two-component waterborne coating system or composition as described in this specification.

The aqueous dispersions of a hydroxy-functional polyacrylic polyol and the aqueous dispersions of a non-functional polyurethane may individually have a solids content in the range of 30% to 60% by weight of the dispersion, or any sub-range subsumed therein, such as, for example, 35% to 55%, 35% to 45%, or 45% to 55%. In various embodiments, a binder component comprising an aqueous dispersion of a hydroxy-functional polyacrylic polyol, an aqueous dispersion of a non-functional polyurethane, and rubber particles may have a combined solids content in the range of 5% to 40%, or any sub-range subsumed therein, such as, for example, 15% to 30%.

The two-component waterborne coating systems and compositions described in this specification may be formulated so that the isocyanate-to-hydroxyl (NCO:OH) ratio of the water-dispersible polyisocyanate crosslinker component (B) to the hydroxy-functional polyacrylic polyol component (A1) of the binder component (A) is 1:5 to 5:1, and in some embodiments, 1:3 to 3:1, 1:2 to 2:1, 1:1.5 to 1.51, 0.5:1 to 5:1, or 1.5:1 to 3:1. The two-component waterborne coating systems and compositions described in this specification may be formulated so that an approximately 1:1 mixture by volume of binder component (A) and crosslinker component (B) forms a coating composition having an NCO:OH ratio as described above.

In various non-limiting embodiments, the two-component waterborne coating systems and compositions described in this specification may comprise components (A1), (A2), (A3), and (B) in the weight percentage ranges (parts by weight) specified above or in any sub-ranges or values subsumed within the ranges specified above. For example, the two-component waterborne coating systems and compositions described in this specification may comprise 20% to 40% by weight on a solids basis of a water-dispersible hydroxy-functional polyacrylic polyol. The two-component waterborne coating systems and compositions described in this specification may comprise 0% to 20% or by weight on a solids basis of a water-dispersible non-functional polyurethane. The two-component waterborne coating systems and compositions described in this specification may comprise 10% to 30% by weight on a solids basis of rubber particles. The two-component waterborne coating systems and compositions described in this specification may comprise 40% to 70% by weight on a solids basis of a water-dispersible polyisocyanate. The relative amounts of the various components specified above may produce a waterborne coating composition that when applied to a substrate and cured to form a polyurethane film exhibits a soft feel effect and also exhibits no greater than a 2 rating, and in some embodiments, no greater than a 1 rating, determined in accordance with GMW14445.

The two-component waterborne coating systems and compositions described in this specification may form cured polyurethane coating films in which the average particle size of the rubber particles is greater than the dry film thickness (DFT) of the cured polyurethane coating films. For example, a cured polyurethane coating film may have a DFT in the range of 25 microns to 75 microns, and the average particle size of the rubber particles comprising the film is greater than the DFT. A cured polyurethane coating film may have a DFT in the range of 25 microns to 45 microns, and comprise rubber particles having an average particle size of 50 microns. In various embodiments, a cured polyurethane coating film may comprise rubber particles having an average particle size that is from 3 microns to 50 microns greater than the DFT of the a cured polyurethane coating film, or any sub-range or value subsumed therein, such as, for example, 5 microns to 25 microns greater than the DFT of the a cured polyurethane coating film.

The non-limiting and non-exhaustive examples that follow are intended to further describe various non-limiting and non-exhaustive embodiments without restricting the scope of the embodiments described in this specification.

### EXAMPLES

In the following Examples, “Additives” represents an additive package consisting of Tego Foamex 805, ZetaSperse 3100, Byk-346.

Bayhydrol® A 2695 is an aqueous hydroxyl-functional polyacrylic dispersion; hydroxyl content 5% by weight; acid number 9.4 mg KOH/g.

Bayhydur® 302 is a solvent-free, water-dispersible polyisocyanate based on HDI; NCO Content % 17.3; Equivalent weight (avg) 243.

Bayhydur XP 2487/1 is a CAPS-modified biuret- and isocyanurate-group containing polyisocyanate based on HDI; NCO content 20.6% by weight; equivalent weight (avg) 204.

Coating compositions were prepared using the ingredients and amounts (in grams) listed in Table 1. The compositions were prepared as follows: Component one was combined with component two based on the amounts in the appropriate formulation. The components were combined under agitation using a mechanical stir and an impeller blade for approximately 60 seconds.

The compositions were applied to were applied at 1 mil dry film thickness to a PCS/ABS panel using a draw down bar. The panels were cured 60 min @ 80° C. The panels were then tested for sunscreen and insect repellent resistance according to GMW14445. Results are set forth in Table 2.

### Examples 1-20

TABLE 1

| | 1 | 2 | 3 | 4 | 5 | 6 | 7 | 8 | 9 | 10 |
|---|---|---|---|---|---|---|---|---|---|---|
| Component | | | | | | | | | | |
| 1 | | | | | | | | | | |
| Bayhydrol | 32 | 32 | 32 | 32 | 32 | 32 | 32 | 24 | 24 | 24 |
| A 2695 | | | | | | | | | | |
| Additives | 1.5 | 2.33 | 3.6 | 4.91 | 2.33 | 3.6 | 4.91 | 1.3 | 1.78 | 1.78 |
| Water, DI | 33.78 | 33.78 | 33.78 | 33.78 | 33.78 | 33.78 | 33.78 | 25.82 | 25.82 | 25.82 |
| Rubberized | | | | | 8.55 | 17.1 | 25.65 | | | 3.21 |
| pigment | | | | | | | | | | |
| (50 micron) | | | | | | | | | | |
| Rubberized | | 8.55 | 17.1 | 25.65 | | | | | 3.21 | |
| pigment | | | | | | | | | | |
| (75 micron) | | | | | | | | | | |
| Silica | 4.22 | 4.22 | 4.22 | 4.22 | 4.22 | 4.22 | 4.22 | 3.17 | 3.17 | 3.17 |
| Butyl | 5.73 | 5.73 | 5.73 | 5.73 | 5.73 | 5.73 | 5.73 | 4.3 | 4.3 | 4.3 |
| Carbitol | | | | | | | | | | |
| Component | | | | | | | | | | |
| 2 | | | | | | | | | | |
| Bayhydur | 17.56 | 17.56 | 17.56 | 17.56 | 17.56 | 17.56 | 17.56 | 13.1 | 13.1 | 13.1 |
| 302 and | | | | | | | | | | |
| Bayhydur | | | | | | | | | | |
| XP 2487/1¹ | | | | | | | | | | |
| | 11 | 12 | 13 | 14 | 15 | 16 | 17 | 18 | 19 | 20 |
| Component | | | | | | | | | | |
| 1 | | | | | | | | | | |
| Bayhydrol | 32 | 32 | 32 | 32 | 32 | 32 | 32 | 32 | 32 | 32 |
| A 2695 | | | | | | | | | | |
| Additives | 1.97 | 2.33 | 3.6 | 4.9 | 2.33 | 3.6 | 4.9 | 1.5 | 1.7 | 1.7 |
| Water, DI | 33.78 | 33.78 | 33.78 | 33.78 | 33.78 | 33.78 | 33.78 | 33.58 | 33.58 | 33.58 |
| Rubberized | | | | | 8.55 | 17.1 | 25.65 | | | 4.26 |
| pigment | | | | | | | | | | |
| (50 micron) | | | | | | | | | | |
| Rubberized | | 8.55 | 17.1 | 25.65 | | | | | 4.26 | |
| pigment | | | | | | | | | | |
| (75 micron) | | | | | | | | | | |
| Silica | 4.22 | 4.22 | 4.22 | 4.22 | 4.22 | 4.22 | 4.22 | 4.2 | 4.2 | 4.2 |
| Butyl | 5.73 | 5.73 | 5.73 | 5.73 | 5.73 | 5.73 | 5.73 | 5.71 | 5.71 | 5.71 |
| Carbitol | | | | | | | | | | |
| Component | | | | | | | | | | |
| 2 | | | | | | | | | | |
| Bayhydur | 17.6 | 17.6 | 17.6 | 17.6 | 17.6 | 17.6 | 17.6 | 17.6 | 17.6 | 17.6 |
| 302 and | | | | | | | | | | |
| Bayhydur | | | | | | | | | | |
| XP 2487/1¹ | | | | | | | | | | |

¹A mixture prepared by mixing 100 parts by weight of Bayhydur 302 with 55 parts by weight of Bayhydur 2487/1

TABLE 2

| Formulation | | | | | | | | | | |
|---|---|---|---|---|---|---|---|---|---|---|
| Results | 1 | 2 | 3 | 4 | 5 | 6 | 7 | 8 | 9 | 10 |
| Weight | 32.84 | 38.44 | 43.08 | 46.98 | 38.44 | 43.08 | 46.98 | 32.84 | 35.79 | 35.79 |
| Solids (%) | | | | | | | | | | |
| PVC | 8.14 | 28.74 | 41.6 | 50.82 | 28.74 | 41.8 | 50.82 | 8.14 | 19.76 | 19.76 |
| NCO:OH | 1.5 | 1.5 | 1.5 | 1.5 | 1.5 | 1.5 | 1.5 | 1.5 | 1.5 | 1.5 |
| Mix Ratio (vol) | 4.45:1 | 4.98:1 | 5.51:1 | 6.04:1 | 4.98:1 | 5.51:1 | 6.04:1 | 4.45:1 | 4.72:1 | 4.72:1 |
| P/B | 0.16 | 0.49 | 0.81 | 1.14 | 0.49 | 0.81 | 1.14 | 0.16 | 0.32 | 0.32 |
| % NCO | 0.86 | 0.78 | 0.71 | 0.66 | 0.78 | 0.71 | 0.66 | 0.86 | 0.82 | 0.82 |
| Volume | 29.42 | 34.89 | 39.46 | 43.35 | 34.89 | 39.46 | 43.35 | 29.43 | 32.29 | 32.29 |
| solids (%) | | | | | | | | | | |
| Wt/Gal | 8.78 | 8.84 | 8.89 | 8.93 | 8.84 | 8.89 | 8.93 | 8.79 | 8.82 | 8.82 |
| (lbs/gal) | | | | | | | | | | |
| VOC | 2.86 | 2.39 | 2.05 | 1.8 | 2.39 | 2.05 | 1.8 | 2.86 | 2.6 | 2.6 |
| (lbs/gal) | | | | | | | | | | |
| Sunscreen/ | 1 | 1 | 1 | 1 | 4 | 4 | 4 | 4 | 4 | 4 |
| DEET | | | | | | | | | | |
| Resistance | | | | | | | | | | |
| Rating | | | | | | | | | | |
| Formulation | | | | | | | | | | |
| Results | 11 | 12 | 13 | 14 | 15 | 16 | 17 | 18 | 19 | 20 |
| Weight | 32.84 | 38.45 | 43.08 | 46.98 | 38.45 | 43.08 | 46.98 | 36.67 | 39.08 | 39.08 |
| Solids (%) | | | | | | | | | | |
| PVC | 8.14 | 28.74 | 41.8 | 50.81 | 28.74 | 41.8 | 50.81 | 13.23 | 23.67 | 23.67 |
| NCO:OH | 1.5 | 1.5 | 1.5 | 1.5 | 1.5 | 1.5 | 1.5 | 1.5 | 1.5 | 1.5 |
| Mix Ratio (vol) | 4.45:1 | 4.98:1 | 5.51:1 | 6.04:1 | 4.98:1 | 5.51:1 | 6.04:1 | 4.97:1 | 5.23:1 | 5.23:1 |
| P/B | 0.16 | 0.49 | 0.81 | 1.14 | 0.49 | 0.81 | 1.14 | 0.43 | 0.59 | 0.59 |
| % NCO | 0.86 | 0.78 | 0.71 | 0.66 | 0.78 | 0.71 | 0.66 | 0.75 | 0.72 | 0.72 |
| Volume | 29.43 | 34.89 | 39.46 | 43.35 | 34.89 | 39.46 | 43.35 | 30.12 | 32.72 | 32.72 |
| solids (%) | | | | | | | | | | |
| Wt/Gal | 8.79 | 8.84 | 8.89 | 8.93 | 8.84 | 8.89 | 8.93 | 9.22 | 9.23 | 9.23 |
| (lbs/gal) | | | | | | | | | | |
| VOC | 2.86 | 2.39 | 2.05 | 1.79 | 2.39 | 2.05 | 1.79 | 2.65 | 2.43 | 2.43 |
| (lbs/gal) | | | | | | | | | | |
| Sunscreen/ | 4 | 2 | 3 | 2 | 2 | 2 | 2 | 2 | 2 | 1 |
| DEET | | | | | | | | | | |
| Resistance | | | | | | | | | | |
| Rating | | | | | | | | | | |

6 Evaluation and Rating

| | |
|---|---|
| Rating | Evaluation |
| 1 | No change |
| 2 | Slight change of gloss, color, swelling, or any other tolerable effects |
| 3 | Significant change of color, swelling, blisters, creases or other non-tolerable effects. |
| 4 | Very significant change of color, swelling, blisters, creases or other non-tolerable effects. |

This specification has been written with reference to various non-limiting and non-exhaustive embodiments. However, it will be recognized by persons having ordinary skill in the art that various substitutions, modifications, or combinations of any of the disclosed embodiments (or portions thereof) may be made within the scope of this specification. Thus, it is contemplated and understood that this specification supports additional embodiments not expressly set forth herein. Such embodiments may be obtained, for example, by combining, modifying, or reorganizing any of the disclosed steps, components, elements, features, aspects, characteristics, limitations, and the like, of the various non-limiting embodiments described in this specification. In this manner, Applicant(s) reserve the right to amend the claims during prosecution to add features as variously described in this specification, and such amendments comply with the requirements of 35 U.S.C. §112, first paragraph, and 35 U.S.C. §132(a).

What is claimed is:

1. A two-component waterborne coating system comprising:
(A) a binder component comprising:
(A1) an aqueous dispersion of a hydroxy-functional polyacrylic polyol;
(A2) optionally an aqueous dispersion of a non-functional polyurethane; and
(A3) rubber particles having an average particle size no larger than 100 microns; and
(B) a crosslinker component comprising a water-dispersible sulfonic acid-modified polyisocyanate;
wherein a coating composition comprising component (A) and component (B) forms a cured polyurethane film exhibiting no greater than a 2 rating determined in accordance with GMW14445.

2. The system of claim 1, wherein a mixture of component (A) and component (B) forms a cured polyurethane film exhibiting no greater than a 1 rating determined in accordance with GMW14445.

3. The system of claim 1, wherein the crosslinker component comprises a water-dispersible CAPS-modified polyisocyanate based on 1,6-hexamethylene diisocyanate.

4. The system of claim 1, wherein the non-functional polyurethane comprises a polyester-based polyurethane.

5. The system of claim 1, wherein the rubber particles have an average particle size of no larger than 50 microns.

6. The system of claim 1, wherein the rubber particles comprise rubber recycled from used tires.

7. The system of claim 1, wherein the rubber particles comprise cryogenically ground rubber recycled from used tires.

8. The system of claim 1, comprising 10-20 percent by weight rubber particles having an average particle size no larger than 50 microns based on the total weight of components (A) and (B).

9. A waterborne coating composition comprising a mixture of:
(A) a binder component comprising:
(A1) an aqueous dispersion of a hydroxy-functional polyacrylic polyol;
(A2) an aqueous dispersion of a non-functional polyurethane; and
(A3) rubber particles having an average particle size no larger than 100 microns; and
(B) a crosslinker component comprising a water-dispersible sulfonic acid-modified polyisocyanate;
wherein the coating composition forms a cured polyurethane film exhibiting no greater than a 2 rating determined in accordance with GMW14445.

10. The coating composition of claim 9, wherein the coating composition forms a cured polyurethane film exhibiting no greater than a 1 rating determined in accordance with GMW14445.

11. The coating composition of claim 9, wherein the crosslinker component comprises a water-dispersible CAPS-modified polyisocyanate based on 1,6-hexamethylene diisocyanate.

12. The coating composition of claim 9, wherein the non-functional polyurethane comprises a polyester-based polyurethane.

13. The coating composition of claim 9, wherein the rubber particles have an average particle size of no larger than 50 microns.

14. The coating composition of claim 9, wherein the rubber particles comprise rubber recycled from used tires.

15. The coating composition of claim 9, wherein the rubber particles comprise cryogenically ground rubber recycled from used tires.

16. The coating composition of claim 9, comprising 10-20 percent by weight rubber particles having an average particle size no larger than 50 microns based on the total weight of the coating composition.

17. A coating film applied to a substrate, the coating film comprising:
a first polyurethane comprising a reaction product of a hydroxy-functional polyacrylic polyol and a water-dispersible sulfonic acid-modified polyisocyanate;
a second polyurethane; and
rubber particles having an average particle size no larger than 100 microns
wherein the coating film exhibits no greater than a 2 rating determined in accordance with GMW14445.

18. The coating film of claim 17, wherein the coating film exhibits no greater than a 1 rating determined in accordance with GMW14445.

19. The coating film of claim 17, wherein the water-dispersible sulfonic acid-modified polyisocyanate comprises a water-dispersible CAPS-modified polyisocyanate based on 1,6-hexamethylene diisocyanate, and wherein the second polyurethane comprises a polyester-based polyurethane.

20. The coating film of claim 9, wherein the rubber particles comprise cryogenically ground rubber recycled from used tires and have an average particle size of no larger than 50 microns.
